(19) United States
(12) Patent Application Publication
(10) Pub. No.: US 2021/0064535 A1
(43) Pub. Date: Mar. 4, 2021

(54) MEMORY SYSTEM INCLUDING HETEROGENEOUS MEMORIES, COMPUTER SYSTEM INCLUDING THE MEMORY SYSTEM, AND DATA MANAGEMENT METHOD THEREOF

(71) Applicant: SK hynix Inc., Icheon (KR)

(72) Inventors: Mi Seon HAN, Seoul (KR); Myoung Seo KIM, Icheon (KR); Yun Jeong MUN, Icheon (KR); Eui Cheol LIM, Icheon (KR)

(21) Appl. No.: 16/839,708

(22) Filed: Apr. 3, 2020

(30) Foreign Application Priority Data
Aug. 27, 2019 (KR) 10-2019-0105263

(51) Int. Cl. G06F 12/0882; G06F 12/1009; G06F 12/02; G06F 13/16; G06F 11/30

(52) U.S. Cl. CPC G06F 12/0882; G06F 12/1009; G06F 12/0246; G06F 2212/1024; G06F 13/1673; G06F 13/1657; G06F 11/3037; G06F 13/1689

(57) ABSTRACT

A memory system includes a first memory device having a first memory that includes a plurality of access management regions and a first access latency, each of the access management regions including a plurality of pages, the first memory device configured to detect a hot access management region having an access count that reaches a preset value from the plurality of access management regions, and detect one or more hot pages included in the hot access management region; and a second memory device having a second access latency that is different from the first access latency of the first memory device. Data stored in the one or more hot pages is migrated to the second memory device.

### CROSS-REFERENCE TO RELATED APPLICATION

The present application claims priority under 35 U.S.C. § 119(a) to Korean Patent Application Number 10-2019-0105263, filed on Aug. 27, 2019, in the Korean Intellectual Property Office, which is incorporated herein by reference in its entirety.

### BACKGROUND

### 1. Technical Field

Various embodiments generally relate to a computer system, and more particularly, to a memory device (or memory system) including heterogeneous memories, a computer system including the memory device, and a data management method thereof.

### 2. Related Art

A computer system may include memory devices having various forms. A memory device includes a memory for storing data and a memory controller for controlling an operation of the memory. The memory may include a volatile memory, such as a dynamic random access memory (DRAM), a static random access memory (SRAM), or the like, or a non-volatile memory, such as an electrically erasable and programmable ROM (EEPROM), a ferroelectric RAM (FRAM), a phase change RAM (PCRAM), a magnetic RAM (MRAM), a flash memory, or the like. Data stored in the volatile memory is lost when a power supply is stopped, whereas data stored in the non-volatile memory is not lost although a power supply is stopped. Recently, a memory device on which heterogeneous memories are mounted is being developed.

Furthermore, the volatile memory has a high operating speed, whereas the non-volatile memory has a relatively low operating speed. Accordingly, in order to improve performance of a memory system, frequently accessed data (e.g., hot data) needs to be stored in the volatile memory and less frequently accessed data (e.g., cold data) needs to be stored in the non-volatile memory.

### SUMMARY

Various embodiments are directed to the provision of a memory device (or memory system) including heterogeneous memories, which can improve operation performance, a computer system including the memory device, and a data management method thereof.

In an embodiment, a memory system includes a first memory device having a first memory that includes a plurality of access management regions and a first access latency, each of the access management regions including a plurality of pages, the first memory device configured to detect a hot access management region having an access count that reaches a preset value from the plurality of access management regions, and detect one or more hot pages included in the hot access management region; and a second memory device having a second access latency that is different from the first access latency of the first memory device. Data stored in the one or more hot pages is migrated to the second memory device.

In an embodiment, a computer system includes a central processing unit (CPU); and a memory system electrically coupled to the CPU through a system bus. The memory device includes a first memory device having a first memory that includes a plurality of access management regions and a first access latency, each of the access management regions including a plurality of pages, the first memory device configured to detect a hot access management region having an access count that reaches a preset value from the plurality of access management regions, and detect one or more hot pages included in the hot access management region; and a second memory device having a second access latency different from the first access latency of the first memory device. Data stored in the one or more hot pages is migrated to the second memory device.

In an embodiment, a data management method for a computer system includes transmitting, by the CPU, a hot access management region check command to the first memory device for checking whether a hot access management region is present in a first memory of the first memory device; transmitting, by the first memory device, a first response or a second response to the CPU in response to the hot access management region check command, the first respond including information related to one or more hot pages in the hot access management region, the second response indicating that the hot access management region is not present in the first memory; and transmitting, by the CPU, a data migration command for exchanging hot data, stored in the one or more hot pages of the first memory, with cold data in a second memory of the second memory device, to the first and second memory devices when the first response is received from the first memory device, the first memory device having longer access latency than the second memory device.

In an embodiment, a memory allocation method includes receiving, by a central processing unit (CPU), a page allocation request and a virtual address, checking, by the CPU, the hot page detection history of a physical address corresponding to the received virtual address, and allocating pages, corresponding to the received virtual address, to the first memory of a first memory device and the second memory of a second memory device based on a result of the check.

In an embodiment, a memory device includes a non-volatile memory; and a controller configured to control an operation of the non-volatile memory. The controller is configured to divide the non-volatile memory into a plurality of access management regions, each of which comprises a plurality of pages, include an access count table for storing an access count of each of the plurality of access management regions and a plurality of bit vectors configured with bits corresponding to a plurality of pages included in each of the plurality of access management regions, store an access count of an accessed access management region of the plurality of access management regions in a space of the access count table corresponding to the accessed access management region when the non-volatile memory is accessed, and set, as a first value, a bit corresponding to an accessed page among bits of a bit vector corresponding to the accessed access management region.

According to the embodiments, substantially valid (or meaningful) hot data can be migrated to a memory having a high operating speed because hot pages having a high access count are directly detected in the main memory device. Accordingly, overall operation performance of a system can be improved.

Furthermore, according to the embodiments, a data migration can be reduced and access to a memory having a high operating speed is increased because a page is allocated to a memory having a high operating speed or a memory having a low operating speed depending on a hot page detection history. Accordingly, overall performance of a system can be improved.

### BRIEF DESCRIPTION OF THE DRAWINGS

FIG. 1 illustrates a computer system according to an embodiment.

FIG. 2 illustrates a memory device of FIG. 1 according to an embodiment.

FIG. 3 illustrates pages included in a first memory of FIG. 2 according to an embodiment.

FIG. 4A illustrates a first controller of a first memory device shown in FIG. 2 according to an embodiment.

FIG. 4B illustrates the first controller of the first memory device shown in FIG. 2 according to another embodiment.

FIG. 5A illustrates an access count table (ACT) according to an embodiment.

FIG. 5B illustrates bit vectors (BVs) according to an embodiment.

FIG. 6A illustrates the occurrence of access to an access management region.

FIG. 6B illustrates an ACT in which an access count of an access management region is stored.

FIG. 6C illustrates a bit vector (BV) in which bits corresponding to accessed pages in an access management region are set to a value indicative of a “set state.”

FIGS. 7A and 7B are flowcharts illustrating a data management method according to an embodiment.

FIG. 8 illustrates a data migration between a first memory device and a second memory device according to an embodiment.

FIG. 9A illustrates the least recently used (LRU) queues for a first memory and a second memory according to an embodiment.

FIG. 9B illustrates a first LRU queue and a second LRU queue that are updated after a data exchange according to an embodiment.

FIG. 10A illustrates a page table according to an embodiment.

FIG. 10B illustrates a page mapping entry (PME) of FIG. 10A according to an embodiment.

FIG. 11 is a flowchart illustrating a memory allocation method according to an embodiment.

FIG. 12 illustrates a system according to an embodiment.

FIG. 13 illustrates a system according to another embodiment.

### DETAILED DESCRIPTION

Hereinafter, a memory device (or memory system) including heterogeneous memories, a computer system including the memory device, and a data management method thereof will be described with reference to the accompanying drawings through various examples of embodiments.

FIG. 1 illustrates a computer system 10 according to an embodiment.

The computer system 10 may be any of a main frame computer, a server computer, a personal computer, a mobile device, a computer system for general or special purposes such as programmable home appliances, and so on.

Referring to FIG. 1, the computer system 10 may include a central processing unit (CPU) 100 electrically coupled to a system bus 500, a memory device 200, a storage 300, and an input/output (I/O) interface 400. According to an embodiment, the computer system 10 may further include a cache 150 electrically coupled to the CPU 100.

The CPU 100 may include one or more of various processors which may be commercially used, and may include, for example, one or more of Athlon®, Duron®, and Opteron® processors by AMD®; application, embedded, and security processors by ARM®; Dragonball® and PowerPC® processors by IBM® and Motorola®; a CELL processor by IBM® and Sony®; Celeron®, Core(2) Duo®, Core i3, Core i5, Core i7, Itanium®, Pentium®, Xeon®, and XSCALE® processors by Intel®; and similar processors. A dual microprocessor, a multi-core processor, and another multi-processor architecture may be adopted as the CPU 100.

The CPU 100 may process or execute programs and/or data stored in the memory device 200 (or memory system). For example, the CPU 100 may process or execute the programs and/or the data in response to a clock signal provided by a clock signal generator (not illustrated).

Furthermore, the CPU 100 may access the cache 150 and the memory device 200. For example, the CPU 100 may store data in the memory device 200. Data stored in the memory device 200 may be data read from the storage 300 or data input through the I/O interface 400. Furthermore, the CPU 100 may read data stored in the cache 150 and the memory device 200.

The CPU 100 may perform various operations based on data stored in the memory device 200. For example, the CPU 100 may provide the memory device 200 with a command for performing a data migration between a first memory device 210 and a second memory device 250 that are included in the memory device 200.

The cache 150 refers to a general-purpose memory for reducing a bottleneck phenomenon attributable to a difference in operating speed between a device having a relatively high operating speed and a device having a relatively low operating speed. That is, the cache 150 functions to reduce a data bottleneck phenomenon between the CPU 100 operating at a relatively high speed and the memory device 200 operating at a relatively low speed. The cache 150 may cache data that is stored in the memory device 200 and that is frequently accessed by the CPU 100.

Although not illustrated in FIG. 1, the cache 150 may include a plurality of caches. For example, the cache 150 may include an L1 cache and an L2 cache. In this case, “L” means a level. In general, the L1 cache may be embedded in the CPU 100, and may be first used for data reference and use. The L1 cache has the highest operating speed among the caches in the cache 150, but may have a small storage capacity. If target data is not present in the L1 cache (e.g., cache miss), the CPU 100 may access the L2 cache. The L2 cache has a relatively lower operating speed than the L1 cache, but may have a large storage capacity. If the target data is not present in the L2 cache as well as in the L1 cache, the CPU 100 may access the memory device 200.

The memory device 200 may include the first memory device 210 and the second memory device 250. The first memory device 210 and the second memory device 250 may have different structures. For example, the first memory device 210 may include a non-volatile memory (NVM) and a controller for controlling the non-volatile memory, and the second memory device 250 may include a volatile memory (VM) and a controller for controlling the volatile memory. For example, the volatile memory may be a dynamic random access memory (DRAM) and the non-volatile memory may be a phase change RAM (PCRAM), but embodiments are not limited thereto.

The computer system 10 may store data in the memory device 200 in the short run and temporarily. Furthermore, the memory device 200 may store data having a file system format, or may have a separate read-only space and store an operating system program in the separate read-only space. When the CPU 100 executes an application program, at least part of the application program may be read from the storage 300 and loaded on the memory device 200. The memory device 200 will be described in detail later with reference to subsequent drawings.

The storage 300 may include one of a hard disk drive (HDD) and a solid state drive (SSD). The “storage” refers to a high-capacity storage medium in which user data is stored in the long run by the computer system 10. The storage 300 may store an operation system (OS), an application program, and program data.

The I/O interface 400 may include an input interface and an output interface. The input interface may be electrically coupled to an external input device. According to an embodiment, the external input device may be a keyboard, a mouse, a microphone, a scanner, or the like. A user may input a command, data, and information to the computer system 10 through the external input device.

The output interface may be electrically coupled to an external output device. According to an embodiment, the external output device may be a monitor, a printer, a speaker, or the like. Execution and processing results of a user command that are generated by the computer system 10 may be output through the external output device.

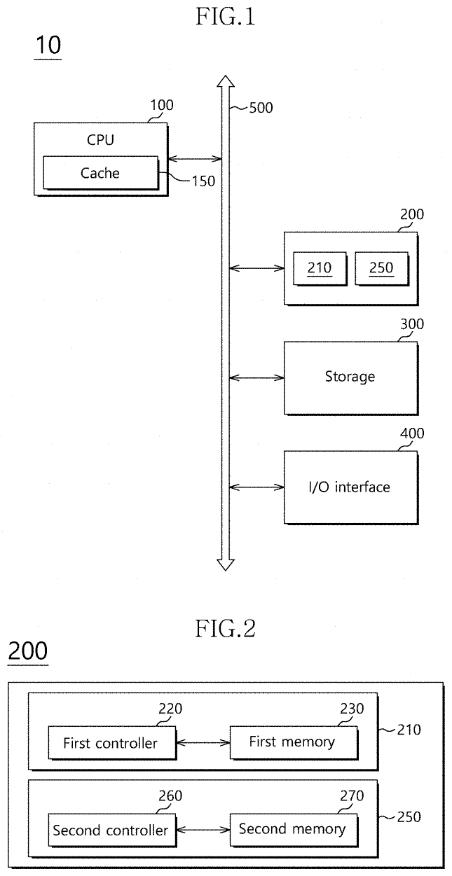

FIG. 2 illustrates the memory device 200 of FIG. 1 according to an embodiment.

Referring to FIG. 2, the memory device 200 may include the first memory device 210 including a first memory 230, e.g., a non-volatile memory, and the second memory device 250 including a second memory 270, e.g., a volatile memory. The first memory device 210 may have a lower operating speed than the second memory device 250, but may have a higher storage capacity than the second memory device 250. The operating speed may include a write speed and a read speed.

As described above, if a cache miss occurs in the cache 150, the CPU 100 may access the memory device 200 and search for target data. Since the second memory device 250 has a higher operating speed than the first memory device 210, if the target data to be retrieved by the CPU 100 is stored in the second memory device 250, the target data can be rapidly accessed compared to a case where the target data is stored in the first memory device 210.

To this end, the CPU 100 may control the memory device 200 to migrate data (hereinafter, referred to as “hot data”), stored in the first memory device 210 and having a relatively large access count, to the second memory device 250, and to migrate data (hereinafter, referred to as “cold data”), stored in the second memory device 250 and having a relatively small access count, to the first memory device 210.

In this case, if the CPU 100 manages an access count of the first memory device 210 in a page unit, hot data and cold data determined by the CPU 100 may be different from actual hot data and cold data stored in the first memory device 210. The reason for this is that, since most of access requests received by the CPU 100 from an external device may be hit in the cache 150 and access to the memory device 200 is only very few, the CPU 100 cannot precisely determine whether accessed data has been stored in the cache 150 or the memory device 200.

Accordingly, in an embodiment, the first memory device 210 of the memory device 200 may check whether a hot access management region in which a hot page is included is present in the first memory 230 in response to a request (or command) from the CPU 100, detect one or more hot pages in the hot access management region, and provide the CPU 100 with information (e.g., addresses) related to the detected one or more hot pages.

The CPU 100 may control the memory device 200 to perform a data migration between the first memory device 210 and the second memory device 250 based on the information provided by the first memory device 210. In this case, the data migration between the first memory device 210 and the second memory device 250 may be an operation for exchanging hot data stored in hot pages in the first memory 230 with cold data stored in cold pages in the second memory 270. A detailed configuration and method therefor will be described later with reference to subsequent drawings.

Referring to FIG. 2, the first memory device 210 may include a first controller 220 in addition to the first memory 230, and the second memory device 250 may include a second controller 260 in addition to the second memory 270. In FIG. 2, each of the first memory 230 and the second memory 270 has been illustrated as one memory block or chip for the simplification of the drawing, but each of the first memory 230 and the second memory 270 may include a plurality of memory chips.

The first controller 220 of the first memory device 210 may control an operation of the first memory 230. The first controller 220 may control the first memory 230 to perform an operation corresponding to a command received from the CPU 100.

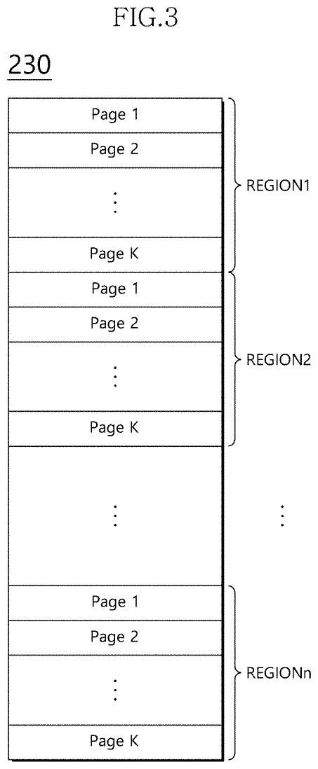

FIG. 3 illustrates an example in which pages included in the first memory 230 of FIG. 2 are grouped into a plurality of access management regions.

Referring to FIG. 3, the first controller 220 may group a data storage region including the pages of the first memory 230 into a plurality of regions REGION1 to REGIONn, n being a positive integer. Each of the plurality of regions REGION1 to REGIONn may include a plurality of pages Page 1 to Page K, K being a positive integer. Hereafter, each of the plurality of regions REGION1 to REGIONn is referred to as an “access management region.”

Referring back to FIG. 2, the first controller 220 may manage an access count of each of the access management regions REGION1 to REGIONn. The reason why the first controller 220 does not manage the access count of the first memory 230 in a page unit, but manages the access count of the first memory 230 in an access management region unit is that if the access count is managed in the page unit, there is a problem in that a storage overhead for storing access counts of pages increases because the first memory 230 has a very high storage capacity. In the present embodiment, in order to prevent an increase in the storage overhead, an access count is managed in the access management region unit rather than the page unit.

Furthermore, the first controller 220 may determine whether a hot access management region in which a hot page is included is present in the first memory 230 based on the access count of each of the access management regions REGION1 to REGIONn. For example, the first controller 220 may determine, as a hot access management region, an access management region that has an access count reaching a preset value. That is, when the access count of the access management region becomes equal to the preset value, the first controller 220 determines the access management region as the hot access management region. Furthermore, the first controller 220 may detect accessed pages in the hot access management region and determine the detected pages as hot pages. For example, the first controller 220 may detect the hot pages using a bit vector (BV) corresponding to the hot access management region.

A process of determining whether the hot access management region is present and detecting the hot pages in the hot access management region will be described in detail later with reference to subsequent drawings.

The first memory 230 may include a memory cell array (not illustrated) configured with a plurality of memory cells, a peripheral circuit (not illustrated) for writing data in the memory cell array or reading data from the memory cell array, and a control logic (not illustrated) for controlling an operation of the peripheral circuit. The first memory 230 may be an non-volatile memory. For example, the first memory 230 may be configured with a PCRAM, but embodiments are not limited thereto. The first memory 230 may be configured with any of various non-volatile memories.

The second controller 260 of the second memory device 250 may control an operation of the second memory 270. The second controller 260 may control the second memory 270 to perform an operation corresponding to a command received from the CPU 100. The second memory 270 may perform an operation of writing data in a memory cell array (not illustrated) or reading data from the memory cell array in response to a command provided by the second controller 260.

The second memory 270 may include the memory cell array configured with a plurality of memory cells, a peripheral circuit (not illustrated) for writing data in the memory cell array or reading data from the memory cell array, and a control logic (not illustrated) for controlling an operation of the peripheral circuit.

The second memory 270 may be a volatile memory. For example, the second memory 270 may be configured with a DRAM, but embodiments are not limited thereto. The second memory 270 may be configured with any of various volatile memories.

The first memory device 210 may have a longer access latency than the second memory device 250. In this case, the access latency means a time from when a memory device receives a command from the CPU 100 to when the memory device transmits a response corresponding to the received command to the CPU 100. Furthermore, the first memory device 210 may have greater power consumption per unit time than the second memory device 250.

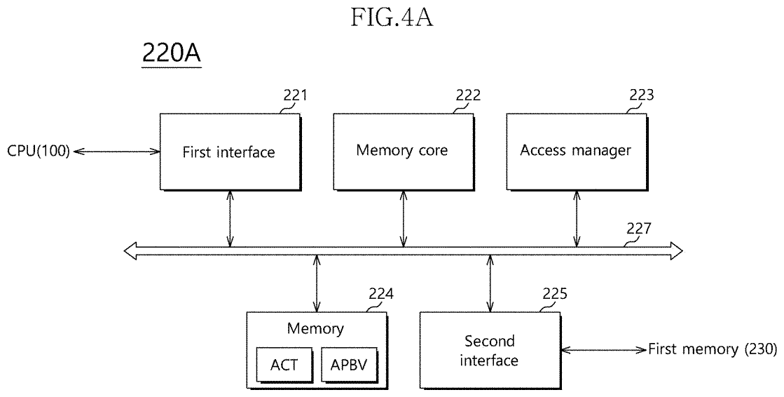

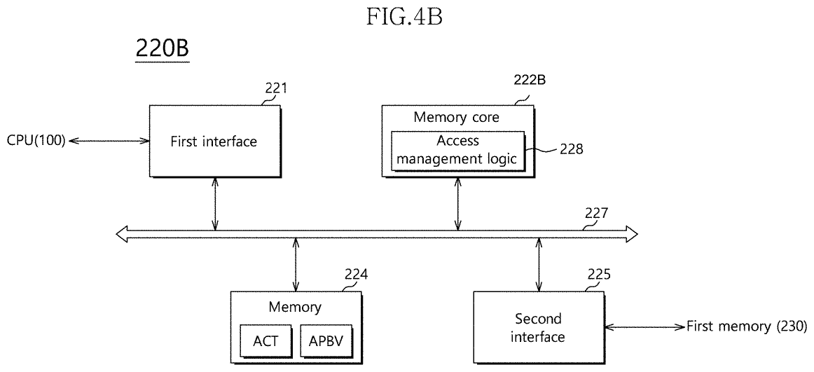

FIG. 4A illustrates the first controller 220 of the first memory device 210 shown in FIG. 2 according to an embodiment.

Referring to FIG. 4A, a first controller 220A may include a first interface 221, a memory core 222, an access manager 223, a memory 224, and a second interface 225.

The first interface 221 may receive a command from the CPU 100 or transmit data to the CPU 100 through the system bus 500 of FIG. 1.

The memory core 222 may control an overall operation of the first controller 220A. The memory core 222 may be configured with a micro control unit (MCU) or a CPU. The memory core 222 may process a command provided by the CPU 100. In order to process the command provided by the CPU 100, the memory core 222 may execute an instruction or algorithm in the form of codes, that is, firmware, and may control the first memory 230 and the internal components of the first controller 220A such as the first interface 221, the access manager 223, the memory 224, and the second interface 225.

The memory core 222 may generate control signals for controlling an operation of the first memory 230 based on a command provided by the CPU 100, and may provide the generated control signals to the first memory 230 through the second interface 225.

The memory core 222 may group the entire data storage region of the first memory 230 into a plurality of access management regions each including a plurality of pages. The memory core 222 may manage an access count of each of the access management regions of the first memory 230 using the access manager 223. Furthermore, the memory core 222 may manage access information for pages, included in each of the access management regions of the first memory 230, using the access manager 223.

The access manager 223 may manage the access count of each of the access management regions of the first memory 230 under the control of the memory core 222. For example, when a page of the first memory 230 is accessed, the access manager 223 may increment an access count corresponding to an access management region including the accessed page in the first memory 230. Furthermore, the access manager 223 may set a bit corresponding to the accessed page, among bits of a bit vector corresponding to the access management region including the accessed page, to a value indicative of a “set state.”

The memory 224 may include an access count table (ACT) configured to store the access count of each of the access management regions of the first memory 230. Furthermore, the memory 224 may include an access page bit vector (APBV) configured with bit vectors respectively corresponding to the access management regions of the first memory 230. The memory 224 may be implemented with an SRAM, a DRAM, or both, but embodiments are not limited thereto.

The second interface 225 may control the first memory 230 under the control of the memory core 222. The second interface 225 may provide the first memory 230 with control signals generated by the memory core 222. The control signals may include a command, an address, and an operation signal for controlling an operation of the first memory 230. The second interface 225 may provide write data to the first memory 230 or may receive read data from the first memory 230.

The first interface 221, the memory core 222, the access manager 223, the memory 224, and the second interface 225 of the first controller 220 may be electrically coupled to each other through an internal bus 227.

FIG. 4B illustrates the first controller 220 of the first memory device 210 shown in FIG. 2 according to another embodiment. In describing a first controller 220B according to the present embodiment with reference to FIG. 4B, a description of the same configuration as that of the first controller 220A illustrated in FIG. 4A will be omitted.

Referring to FIG. 4B, the first controller 220B may include a memory core 222B that includes an access management logic 228. The access management logic 228 may be configured with software or hardware, or a combination thereof. The access management logic 228 may manage the access count of each of the access management regions of the first memory 230 under the control of the memory core 222B. For example, when a page of the first memory 230 is accessed, the access management logic 228 may increment an access count corresponding to an access management region including the accessed page. Furthermore, the access management logic 228 may set a bit corresponding to the accessed page, among bits of a bit vector corresponding to the access management region including the accessed page, to the value indicative of the “set state.”

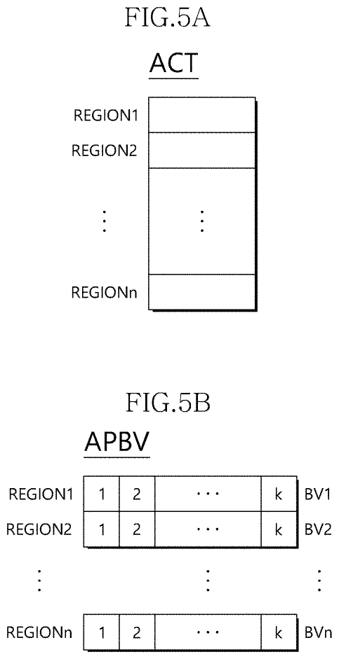

FIG. 5A illustrates an access count table (ACT) according to an embodiment.

Referring to FIG. 5A, the ACT may be configured with spaces in which the access counts of the access management regions REGION1 to REGIONn of the first memory 230 are stored, respectively. Whenever a page of the first memory 230 is accessed, the access manager 223 of the first controller 220 shown in FIG. 4A or the access management logic 228 of the first controller 220B shown in FIG. 4B may store an access count corresponding to an access management region including the accessed page in a corresponding space of the ACT.

FIG. 5B illustrates an access page bit vector (APBV) according to an embodiment.

Referring to FIG. 5B, the APBV may include bit vectors BV1 to BVn respectively corresponding to the access management regions REGION1 to REGIONn of the first memory 230. One bit vector corresponding to one access management region may be configured with k bits respectively corresponding to k pages included in the one access management region. Whenever a page of the first memory 230 is accessed, the access manager 223 of the first controller 220 shown in FIG. 4A or the access management logic 228 of the first controller 220B shown in FIG. 4B may set a bit corresponding to the accessed page, among bits of a bit vector corresponding to an access management region including the accessed page, to a value indicative of a “set state.”

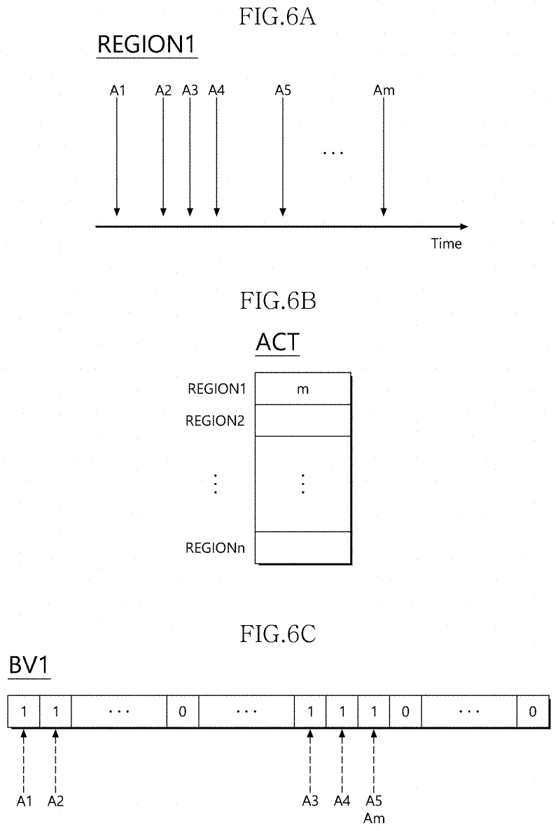

FIG. 6A illustrates the occurrence of access to an access management region. FIG. 6B illustrates an ACT storing an access count of the access management region in which the access has occurred. FIG. 6C illustrates a bit vector in which bits corresponding to accessed pages in the access management region have been set to a value indicative of a “set state.” For illustrative convenience, FIGS. 6A to 6C illustrate that the first access management region REGION1 has been accessed, but the disclosure may be identically applied to each of the second to n-th access management regions REGION2 to REGIONn.

In FIG. 6A, a lateral axis indicates time, and “A1” to “Am” indicate accesses. Whenever a given page in the first access management region REGION1 is accessed, the access manager 223 (or the access management logic 228) may increment an access count stored in a space corresponding to the first access management region REGION1 of the ACT illustrated in FIG. 6B.

For example, as illustrated in FIG. 6A, when a first access A1 to the first access management region REGION1 occurs, an access count “1” may be stored in the space corresponding to the first access management region REGION1 of the ACT illustrated in FIG. 6B. Next, whenever each of the second to m-th accesses A2 to Am to the first access management region REGION1 occurs, the access count stored in the space corresponding to the first access management region REGION1 of the ACT may be increased by one, and may resultantly become “m,” as illustrated in FIG. 6B when the first access management region REGION1 has been accessed m times.

Furthermore, whenever the first access management region REGION1 is accessed, the access manager 223 (or the access management logic 228) may set bits of accessed pages that are included in a bit vector corresponding to the first access management region REGION1 to a value (e.g., “1”) indicative of a “set state.”

For example, when k bits included in the first bit vector BV1 corresponding to the first access management region REGION1 correspond to pages included in the first access management region REGION1, and when, as illustrated in FIG. 6C, pages (e.g., “1,” “2,” “100,” “101,” and “102”) are accessed, bits of the first bit vector BV1 that correspond to the accessed pages (e.g., “1,” “2,” “100,” “101,” and “102”) may be set to “1.” Furthermore, if a bit of the first bit is vector BV1 corresponding to an accessed page is set to the value indicative of the set state, i.e., to the set value “1,” the access manager 223 (or the access management logic 228) may maintain the set value “1” when the accessed page is accessed again.

When the access count of the first access management region REGION1 reaches a preset value (e.g., “m”), the access manager 223 (or the access management logic 228) may determine the first access management region REGION1 as a hot access management region. Furthermore, the access manager 223 (or the access management logic 228) may detect all of the accessed pages in the first access management region REGION1 as hot pages with reference to the first bit vector BV1 corresponding to the first access management region REGION1 that is determined as the hot access management region.

As described above, the first controller 220 of the first memory device 210 manages the access count of each of the access management regions REGION1 to REGIONn of the first memory 230, determines a hot access management region when any of the access counts of the access management regions REGION1 to REGIONn of the first memory 230 reaches the preset value m, and detects one or more hot pages in the hot access management region using a bit vector corresponding to the hot access management region.

Hereinafter, a method of migrating hot data, stored in one or more hot pages of the first memory device 210 that have been detected as described above with reference to FIGS. 6A to 6C, to the second memory device 250 having a high operating speed will be described later in detail.

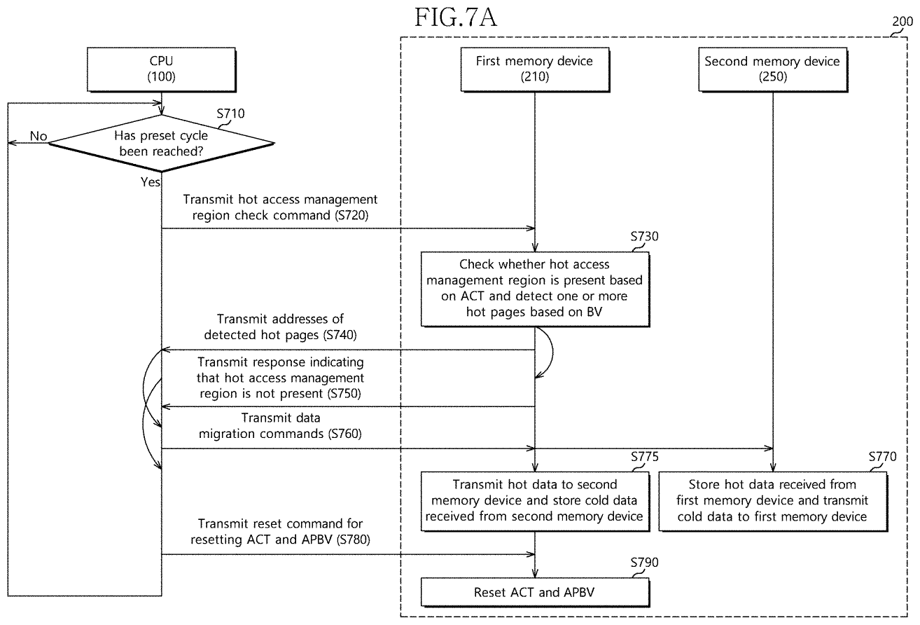

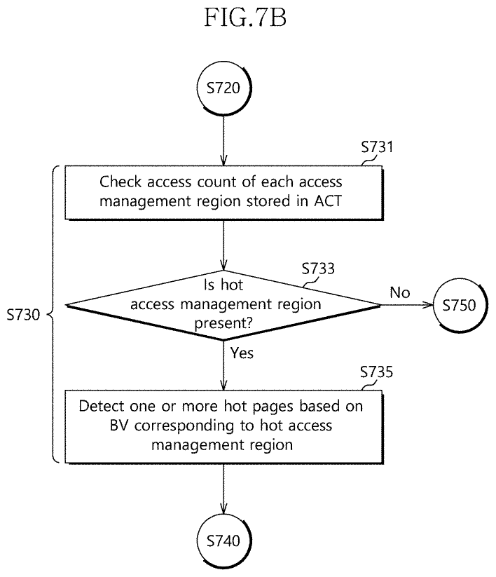

FIG. 7A is a flowchart illustrating a data management method according to an embodiment. The data management method shown in FIG. 7 may be described with reference to at least one of FIGS. 1 to 3, 4A, 4B, 5A, 5B, and 6A to 6C.

At S710, the CPU 100 of FIG. 1 may determine whether a cycle has been reached in order to check whether a hot access management region is present in the first memory 230 of the first memory device 210. The cycle may be preset. If it is determined that the preset cycle has been reached, the process may proceed to S720. That is, the CPU 100 may check whether a hot access management region is present in the first memory 230 of the first memory device 210 every preset cycle. However, embodiments are not limited thereto.

At S720, the CPU 100 may transmit, to the first memory device 210, a command for checking whether the hot access management region is present in the first memory 230 through the system bus 500 of FIG. 1. Herein, the command may be referred to as a “hot access management region check command.”

At S730, the first controller 220 of the first memory device 210 of FIG. 2 may check the ACT in response to the hot access management region check command received from the CPU 100, and may determine whether a hot access management region is present in the first memory 230 based on access counts stored in the ACT. If it is determined that the hot access management region is not present in the first memory 230, the process may proceed to S750.

On the other hand, if it is determined that the hot access management region is present in the first memory 230, the first controller 220 may detect one or more hot pages included in the hot access management region with reference to a bit vector corresponding to the hot access management region. When the one or more hot pages are detected, the process may proceed to S740. The process of determining whether the hot access management region is present or not and detecting hot pages will be described in detail later with reference to FIG. 7B.

At S740, the first controller 220 of the first memory device 210 may transmit, to the CPU 100, addresses of the hot pages detected at S730. Thereafter, the process may proceed to S760.

At S750, the first controller 220 of the first memory device 210 may transmit, to the CPU 100, a response indicating that the hot access management region is not present in the first memory 230. Thereafter, the process may proceed to S780.

At S760, the CPU 100 may transmit data migration commands to the first memory device 210 and the second memory device 250.

The data migration command transmitted from the CPU 100 to the first memory device 210 may include a command for migrating hot data, stored in the one or more hot pages included in the first memory 230 of the first memory device 210, to the second memory 270 of the second memory device 250 and a command for storing cold data, received from the second memory device 250, in the first memory 230.

Furthermore, the data migration command transmitted from the CPU 100 to the second memory device 250 may include a command for migrating the cold data, stored in one or more cold pages of the second memory 270 of the second memory device 250, to the first memory 230 of the first memory device 210 and a command for storing the hot data, received from the first memory device 210, in the second memory 270. Accordingly, after the data migration commands are transmitted from the CPU 100 to the first memory device 210 and the second memory device 250 at S760, the process may proceed to S770 and S775. For example, S770 and S775 may be performed at the same time or at different times.

At S770, the second controller 260 of the second memory device 250 may read the cold data from the one or more cold pages of the second memory 270 in response to the data migration command received from the CPU 100, temporarily store the cold data in a buffer memory (not illustrated), and store the hot data, received from the first memory device 210, in the one or more cold pages of the second memory 270. Furthermore, the second controller 260 may transmit, to the first memory device 210, the cold data temporarily stored in the buffer memory.

In another embodiment, if the second memory 270 of the second memory device 250 includes an empty page, the process of reading the cold data from the one or more cold pages and temporarily storing the cold data in the buffer memory may be omitted. Instead, the hot data received from the first memory device 210 may be stored in the empty page of the second memory 270.

However, in order to migrate the hot data of the first memory 230 to the second memory 270 when the second memory 270 is full of data, the hot data needs to be exchanged for the cold data stored in the second memory 270. To this end, the CPU 100 may select the cold data from data stored in the second memory 270 and exchange the cold data for the hot data of the first memory 230. A criterion for selecting cold data may be an access timing or sequence of data. For example, the CPU 100 may select, as cold data, data stored in the least used page among the pages of the second memory 270, and exchange the selected cold data for the hot data of the first memory 230.

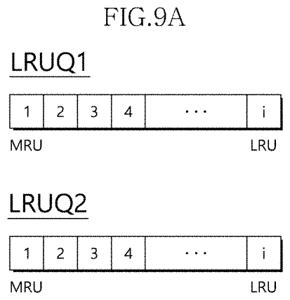

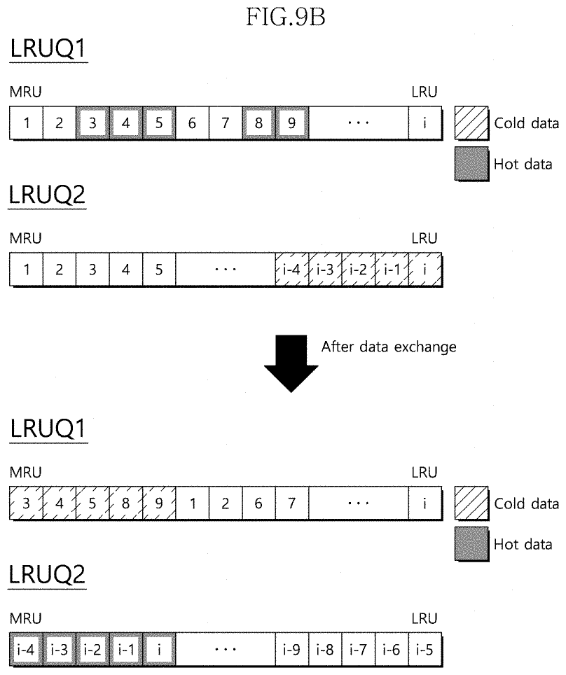

Before the CPU 100 transmits the data migration commands to the first memory device 210 and the second memory device 250 at S760, the CPU 100 may select cold data in the second memory 270 of the second memory device 250, and may include an address of a cold page, in which the selected cold data is stored, in the data migration command to be transmitted to the second memory device 250. A method of selecting, by the CPU 100, cold data in the second memory 270 will be described in detail later with reference to FIG. 9A.

At S775, the first controller 220 of the first memory device 210 may read the hot data from the one or more hot pages included in the hot access management region of the first memory 230 in response to the data migration command received from the CPU 100, transmit the hot data to the second memory device 250, and store the cold data, received from the second memory device 250, in the first memory 230.

At S780, the CPU 100 may transmit, to the first memory device 210, a reset command for resetting values stored in the ACT and the APBV. In the present embodiment, the CPU 100 sequentially transmits the hot access management region check command, the data migration command, and the reset command, but embodiments are not limited thereto. In another embodiment, the CPU 100 may transmit, to the first and second memory devices 210 and 250, a single command including all the above commands.

At S790, the first controller 220 of the first memory device 210 may reset the values (or information) stored in the ACT and the APBV in response to the reset command received from the CPU 100.

FIG. 7B is a detailed flowchart of S730 in FIG. 7A according to an embodiment.

At S731, the first controller 220 may check values stored in the ACT, i.e., the access count of each of the access management regions REGION1 to REGIONn in the first memory 230.

At S733, the first controller 220 may determine whether a hot access management region is present among the access management regions REGION1 to REGIONn based on the access count of each of the access management regions REGION1 to REGIONn. For example, if an access count of any of the access management regions REGION1 to REGIONn reaches a preset value (e.g., “m”), e.g., if there is an access management region having an access count that is equal to or greater than the preset value m among the access management regions REGION1 to REGIONn, the first controller 220 may determine that the hot access management region is present among the access management regions REGION1 to REGIONn. If it is determined that the hot access management region is present, the process may proceed to S735. If it is determined that the hot access management region is not present among the access management regions REGION1 to REGIONn, the process may proceed to S750 of FIG. 7A.

At S735, the first controller 220 may detect one or more hot pages included in the hot access management region with reference to a bit vector corresponding to the hot access management region. For example, the first controller 220 may detect, as hot pages, pages corresponding to bits that have been set to a value (e.g., “1”) indicative of a “set state.” When the detection of the hot pages is completed, the process may proceed to S740 of FIG. 7A.

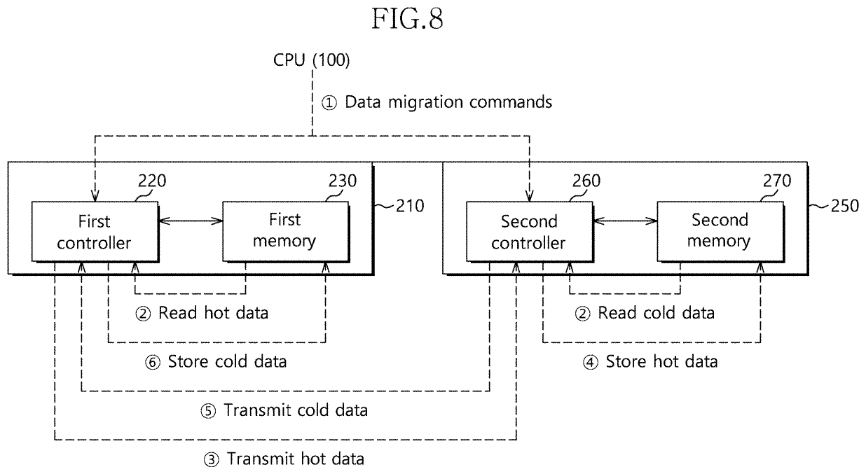

FIG. 8 illustrates a data migration between a first memory device and a second memory device according to an embodiment. The configurations illustrated in FIGS. 1 and 2 will be used to describe the data migration illustrated in FIG. 8.

Referring to FIG. 8, the CPU 100 may transmit data migration commands to the first memory device 210 and the second memory device 250 through the system bus 500 (\textcircled{1}).

In this case, the data migration command transmitted to the first memory device 210 may include addresses of hot pages, in which hot data is stored, in the first memory 230, a read command for reading the hot data from the hot pages, and a write command for storing cold data transmitted from the second memory device 250, but embodiments are not limited thereto.

Furthermore, the data migration command transmitted to the second memory device 250 may include addresses of cold pages, in which cold data is stored, in the second memory 270, a read command for reading the cold data from the cold pages, and a write command for storing the hot data transmitted from the first memory device 230, but embodiments are not limited thereto.

The second controller 260 of the second memory device 250 that has received the data migration command from the CPU 100 may read the cold data from the cold pages of the second memory 270, and temporarily store the read cold data in a buffer memory (not illustrated) included in the second controller 260 (\textcircled{2}). Likewise, the first controller 220 of the first memory device 210 may read the hot data from the hot pages of the first memory 230 based on the data migration command (\textcircled{2}), and transmit the read hot data to the second controller 260 (\textcircled{3}).

The second controller 260 may store the hot data, received from the first memory device 210, in the second memory 270 (\textcircled{4}). In this case, a region of the second memory 270 in which the hot data is stored may correspond to the cold pages in which the cold data was stored.

Furthermore, the second controller 260 may transmit, to the first memory device 210, the cold data temporarily stored in the buffer memory (\textcircled{5}). The first controller 220 may store the cold data, received from the second memory device 250, in the first memory 230 (\textcircled{6}). In this case, a region of the first memory 230 in which the cold data is stored may correspond to the hot pages in which the hot data was stored. Accordingly, the exchange between the hot data of the first memory 230 and the cold data of the second memory 270 may be completed.

FIG. 9A illustrates the least recently used (LRU) queues for a first memory and a second memory according to an embodiment. The configurations illustrated in FIGS. 1 and 2 will be used to describe the LRU queues illustrated in FIG. 9A.

The CPU 100 may select, in the second memory 270, cold pages that store cold data to be exchanged for hot data of the first memory 230, using an LRU queue for the second memory 270.

The CPU 100 may separately manage the LRU queues for the first memory 230 and the second memory 270. Hereinafter, the LRU queue for the first memory 230 may be referred to as a “first LRU queue LRUQ1,” and the LRU queue for the second memory 270 may be referred to as a “second LRU queue LRUQ2.”

The first LRU queue LRUQ1 and the second LRU queue LRUQ2 may be stored in the first memory 230 and the second memory 270, respectively. However, embodiments are not limited thereto. The first LRU queue LRUQ1 and the second LRU queue LRUQ2 may have the same configuration. For example, each of the first LRU queue LRUQ1 and the second LRU queue LRUQ2 may include a plurality of storage spaces for storing addresses corresponding to a plurality of pages.

An address of the most recently used (MRU) page may be stored in the first storage space on one side of each of the first LRU queue LRUQ1 and the second LRU queue LRUQ2. The first storage space on the one side in which the address of the MRU page is stored may be referred to as an “MRU space.” An address of the least recently (or long ago) used (LRU) page may be stored in the first space on the other side of each of the first LRU queue LRUQ1 and the second LRU queue LRUQ2. The first storage space on the other side in which the address of the LRU page is stored may be referred to as an “LRU space.”

Whenever the first memory 230 and the second memory 270 are accessed, the address of the accessed page stored in the MRU space of each of the first LRU queue LRUQ1 and the second LRU queue LRUQ2 may be updated with an address of the newly accessed page. At this time, each of the addresses of the remaining accessed pages stored in the other storage spaces in each of the first LRU queue LRUQ1 and the second LRU queue LRUQ2 may be migrated to the next storage space toward the LRU space by one storage space.

The CPU 100 may check the least recently (or long go) used page in the second memory 270 with reference to the second LRU queue LRUQ2, and determine data, stored in the corresponding page, as cold data to be exchanged for hot data of the first memory 230. Furthermore, if the number of hot data is plural, the CPU 100 may select cold data, corresponding to the number of hot data, from one or more LRU spaces of the second LRU queue LRUQ2 toward the MRU space.

Furthermore, when the exchange between the hot data of the first memory 230 and the cold data of the second memory 270 is completed, the CPU 100 may update address information, that is, the page addresses stored in the MRU spaces of the first LRU queue LRUQ1 and the second LRU queue LRUQ2. Furthermore, if the number of hot data is plural, whenever the exchange between the hot data of the first memory 230 and the cold data of the second memory 270 is completed, the CPU 100 may update the page addresses stored in the MRU spaces of the first LRU queue LRUQ1 and the second LRU queue LRUQ2.

FIG. 9B illustrates the first LRU queue LRUQ1 and the second LRU queue LRUQ2 that have been updated after a data exchange according to an embodiment.

As described above, for a data migration between the first memory 230 and the second memory 270, the CPU 100 may access a hot page of the first memory 230 in which hot data is stored, and may access a cold page of the second memory 270 that corresponds to an address stored in the LRU space of the second LRU queue LRUQ2. Accordingly, an address of the hot page recently accessed in the first memory 230 may be newly stored in the MRU space of the first LRU queue LRUQ1. Furthermore, an address of the cold page recently accessed in the second memory 270 may be newly stored in the MRU space of the second LRU queue LRUQ2. As the address is newly stored in the MRU space of each of the first LRU queue LRUQ1 and the second LRU queue LRUQ2, an address originally stored in the MRU space and subsequent addresses thereof may be migrated toward the LRU space by one storage space.

Referring to FIG. 9B, the number of hot pages detected in the first memory 230 is five. It is assumed that addresses of the five hot pages are “3,” “4,” “5,” “8,” and “9.” A page corresponding to an address that is stored in a storage space farther away from the MRU space indicates a less recently used page. If the five hot pages are aligned in order of the least recently used pages, it may result in the address sequence of “9,” “8,” “5,” “4,” and “3.”

In order to migrate hot data, stored in the five hot pages, to the second memory 270, the CPU 100 may select five cold pages in the second memory 270 with reference to the second LRU queue LRUQ2. The CPU 100 may select five cold pages “i,” “i-1,” “i-2,” “i-3,” and “i-4” from the LRU space of the second LRU queue LRUQ2 toward the MRU space of the second LRU queue LRUQ2.

Assuming that hot data stored in a hot page accessed long ago, among the hot pages “3,” “4,” “5,” “8,” and “9,” is first exchanged for cold data, hot data stored in the hot page “9” may be first exchanged for cold data stored in the cold page “i.” As a result, although not illustrated in FIG. 9B, the address “9” is newly stored in the MRU space of the first LRU queue LRUQ1, and each of the addresses “1” to “8” is migrated to the right toward the LRU space by one storage space. Furthermore, the address “i” is newly stored in the MRU space of the second LRU queue LRUQ2, and each of the addresses “1” to “i-1” is migrated to the right toward the LRU space by one storage space.

Hot data stored in the hot page “8” may be secondly exchanged for cold data stored in the cold page “i-1.” As a result, although not illustrated in FIG. 9B, the address “8” is newly stored in the MRU space of the first LRU queue LRUQ1, and each of the addresses “9” and “1” to “7” is migrated to the right toward the LRU space by one storage space. Furthermore, the address “i-1” is newly stored in the MRU space of the second LRU queue LRUQ2, and each of the addresses “1” to “i-2” is migrated to the right toward the LRU space by one storage space.

Subsequently, hot data stored in the hot page “5” may be thirdly exchanged for cold data stored in the cold page “i-2.” As a result, although not illustrated in FIG. 9B, the address “5” is newly stored in the MRU space of the first LRU queue LRUQ1, and each of the addresses “8,” “9,” and “1” to “4” is migrated to the right toward the LRU space by one storage space. Furthermore, the address “i-2” is newly stored in the MRU space of the second LRU queue LRUQ2, and each of the addresses “1” to “i-3” is migrated to the right toward the LRU space by one storage space.

Thereafter, hot data stored in the hot page “4” may be fourthly exchanged for cold data stored in the cold page “i-3.” As a result, although not illustrated in FIG. 9B, the address “4” is newly stored in the MRU space of the first LRU queue LRUQ1, and each of the addresses “5,” “8,” “9,” and “1” to “3” is migrated to the right toward the LRU space by one storage space. Furthermore, the address “i-3” is newly stored in the MRU space of the second LRU queue LRUQ2, and each of the addresses “1” to “i-4” is migrated to the right toward the LRU space by one storage space.

Hot data stored in the hot page “3” may be finally exchanged for cold data stored in the cold page “i-4.” As a result, although not illustrated in FIG. 9B, the address “3” is newly stored in the MRU space of the first LRU queue LRUQ1, and each of the addresses “4,” “5,” “8,” “9,” and “1” to “2” is migrated to the right toward the LRU space by one storage space. Furthermore, the address “i-4” is newly stored in the MRU space of the second LRU queue LRUQ2, and each of the addresses “1” to “i-5” is migrated to the right toward the LRU space by one storage space.

After the data exchange is completed, the address “3” is stored in the MRU space of the first LRU queue LRUQ1, and the address “i” is still stored in the LRU space. Furthermore, the address “i-4” is stored in the MRU space of the second LRU queue LRUQ2, and the address “i-5” is migrated and stored in the LRU space.

When the data exchange is completed, the first controller 220 of the first memory device 210 may perform a reset operation for resetting values (or information) stored in the ACT and APBV of the memory 224.

In an embodiment, whenever at least one command of a hot access management region command, a data migration command, and a reset command is provided by the CPU 100, the first controller 220 may reset the ACT and the APBV regardless of whether a hot access management region is present in the first memory 230 and whether to perform a data migration.

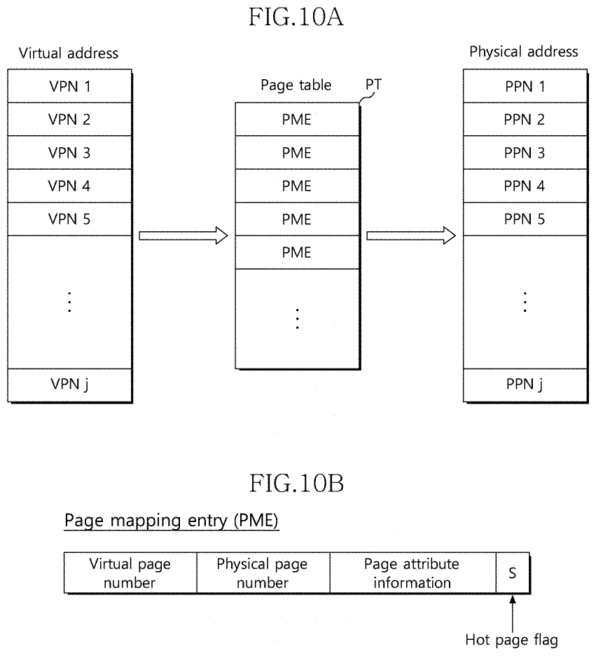

FIG. 10A illustrates a page table (PT) for mapping between a virtual address and a physical address according to an embodiment.

Referring to FIG. 10A, the PT may have a data structure including mapping information between a virtual address and a physical address (or actual address). The PT may be configured with a plurality of page mapping entries (PMEs) that include a plurality of virtual page numbers VPN1 to VPNj and a plurality of physical page numbers PPN1 to PPNj mapped to the plurality of virtual page numbers VPN1 to VPNj, respectively. The CPU 100 may convert a virtual address into a physical address with reference to the PT, and may access a page corresponding to the converted physical address.

FIG. 10B illustrates a page mapping entry (PME) of FIG. 10A according to an embodiment.

Referring to FIG. 10B, the PME may include a virtual page number and a physical page number mapped to the virtual page number. Furthermore, the PME may include page attribute information. The page attribute information may include information defining characteristics of a page related to the PME, such as read possibility, write possibility, cache memory possibility, and level access restriction for the page related to the PME, but embodiments are not limited thereto. Furthermore, the PME may include a hot page flag S indicating whether the page related to the PME is a hot page. The PME is not limited to the format illustrated in FIG. 10B. In other embodiments, the PME may have various ranges of other formats.

When addresses of hot pages are received from the first memory device 210, the CPU 100 may set, as a value indicative of a “set state,” hot page flags of PMEs in the PT that include physical addresses (i.e., physical page numbers) corresponding to the addresses of the hot pages. After that, when allocating a memory, the CPU 100 may check a hot page flag of a PME corresponding to a virtual address with reference to the PT, and allocate a page of the virtual address to the first memory 230 of the first memory device 210 or to the second memory 270 of the second memory device 250 according to a value of the hot page flag.

For example, when the hot page flag has the set value, the CPU 100 may allocate the page of the virtual address to the second memory 270 of the second memory device 250. On the other hand, when the hot page flag does not have the set value, the CPU 100 may allocate the page of the virtual address to the first memory 230 of the first memory device 210.

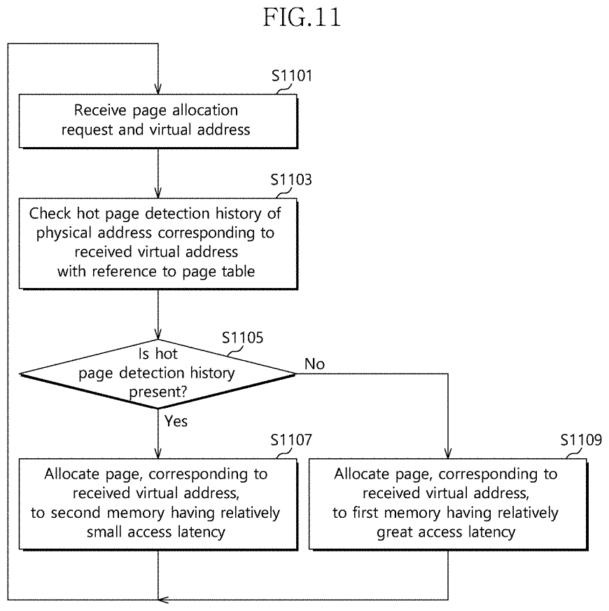

FIG. 11 is a flowchart illustrating a memory allocation method according to an embodiment. The memory allocation method illustrated in FIG. 11 may be described with reference to at least one of FIGS. 1 to 3, 4A, 4B, 5A, 5B, 6A to 6C, 7A, 7B, 8, 9A, 9B, 10A, and 10B.

At S1101, the CPU 100 may receive a page allocation request and a virtual address from an external device. In another embodiment, the page allocation request may be received from an application program. However, embodiments are not limited thereto.

At S1103, the CPU 100 may check a hot page detection history of a physical address corresponding to the received virtual address with reference to a page table (PT). For example, the CPU 100 may check the hot page detection history of the corresponding physical address by checking a hot page flag of a page mapping entry (PME), which includes a virtual address number corresponding to the received virtual address, among the plurality of PMEs included in the PT of FIG. 10A.

At S1105, the CPU 100 may determine whether the hot page detection history of the physical address corresponding to the received virtual address is present. For example, if the hot page flag of the PME including the received virtual address has been set to the set value, the CPU 100 may determine that the hot page detection history of the corresponding physical address is present. If the hot page flag of the PME including the received virtual address has not been set to the set value, e.g., has been set to a value indicative of a “reset state,” the CPU 100 may determine that the hot page detection history of the corresponding physical address is not present.

If it is determined that the hot page detection history is present, the process may proceed to S1107. Furthermore, if it is determined that the hot page detection history is not present, the process may proceed to S1109.

At S1107, the CPU 100 may allocate a page, corresponding to the received virtual address, to the second memory 270 having a relatively short access latency.

At S1109, the CPU 100 may allocate the page, corresponding to the received virtual address, to the first memory 230 having a relatively long access latency.

As described above, a page corresponding to a virtual address is allocated to the first memory 230 or the second memory 270 based on a hot page detection history of a physical address related to the virtual address received along with a page allocation request. Accordingly, overall performance of a system can be improved because a data migration is reduced and access to a memory having a relatively short access latency is increased.

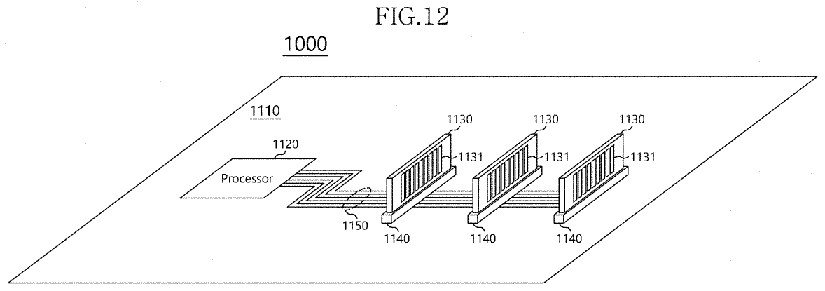

FIG. 12 illustrates a system 1000 according to an embodiment. In FIG. 12, the system 1000 may include a main board 1110, a processor 1120, and a memory module 1130. The main board 1110 is a substrate on which parts configuring the system is mounted. The main board 1110 may be called a mother board. The main board 1110 may include a slot (not illustrated) on which the processor 1120 may be mounted and a slot 1140 on which the memory module 1130 may be mounted. The main board 1110 may include a wiring 1150 for electrically coupling the processor 1120 and the memory module 1130. The processor 1120 may be mounted on the main board 1110. The processor 1120 may include any of a CPU, a graphic processing unit (GPU), a multi-media processor (MMP), a digital signal processor, and so on. Furthermore, the processor 1120 may be implemented in a system-on-chip form by combining processor chips having various functions like an application processor (AP).

The memory module 1130 may be mounted on the main board 1110 through the slot 1140 of the main board 1110. The memory module 1130 may be electrically coupled to the wiring 1150 of the main board 1110 through the slot 1140 and module pins formed in a module substrate of the memory module 1130. The memory module 1130 may include one of an unbuffered dual inline memory module (UDIMM), a dual inline memory module (DIMM), a registered dual inline memory module (RDIMM), a load reduced dual inline memory module (LRDIMM), a small outline dual inline memory module (SODIMM), a non-volatile dual inline memory module (NVDIMM), and so on.

The memory device 200 illustrated in FIG. 1 may be applied as the memory module 1130. The memory module 1130 may include a plurality of memory devices 1131. Each of the plurality of memory devices 1131 may include a volatile memory device or a non-volatile memory device. The volatile memory device may include an SRAM, a DRAM, an SDRAM, or the like. The non-volatile memory device may include a ROM, a PROM, an EEPROM, an EPROM, a flash memory, a PRAM, an MRAM, an RRAM, an FRAM, or the like.

The first memory device 210 of the memory device 200 illustrated in FIG. 1 may be applied as the memory device 1131 including the non-volatile memory device. Furthermore, the memory device 1131 may include a stack memory device or a multi-chip package formed by stacking a plurality of chips.

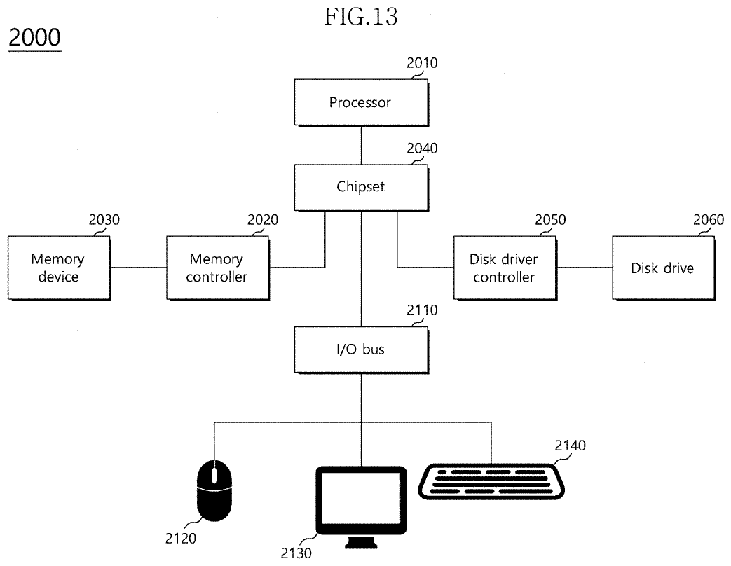

FIG. 13 illustrates a system 2000 according to an embodiment. In FIG. 13, the system 2000 may include a processor 2010, a memory controller 2020, and a memory device 2030. The processor 2010 may be electrically coupled to the memory controller 2020 through a chipset 2040. The memory controller 2020 may be electrically coupled to the memory device 2030 through a plurality of buses. In FIG. 13, the processor 2010 is illustrated as being one, but embodiments are not limited thereto. In another embodiment, the processor 2010 may include a plurality of processors physically or logically.

The chipset 2040 may provide a communication path along which a signal is transmitted between the processor 2010 and the memory controller 2020. The processor 2010 may transmit a request and data to the memory controller 2020 through the chipset 2040 in order to perform a computation operation and to input and output desired data.

The memory controller 2020 may transmit a command signal, an address signal, a clock signal, and data to the memory device 2030 through the plurality of buses. The memory device 2030 may receive the signals from the memory controller 2020, store the data, and output stored data to the memory controller 2020. The memory device 2030 may include one or more memory modules. The memory device 200 of FIG. 1 may be applied as the memory device 2030.

In FIG. 13, the system 2000 may further include an input/output (I/O) bus 2110, I/O devices 2120, 2130, and 2140, a disk driver controller 2050, and a disk drive 2160. The chipset 2040 may be electrically coupled to the I/O bus 2110. The I/O bus 2110 may provide a communication path for signal transmission between the chipset 2040 and the I/O devices 2120, 2130, and 2140. The I/O devices 2120, 2130, and 2140 may include the mouse 2120, the video display 2130, and the keyboard 2140. The I/O bus 2110 may include any communication protocol for communication with the I/O devices 2120, 2130, and 2140. In an embodiment, the I/O bus 2110 may be integrated into the chipset 2040.

The disk driver controller 2050 may be electrically coupled to the chipset 2040. The disk driver controller 2050 may provide a communication path between the chipset 2040 and one or more disk drives 2060. The disk drive 2060 may be used as an external data storage by storing a command and data. The disk driver controller 2050 and the disk drive 2060 may communicate with each other or communicate with the chipset 2040 using any communication protocol including the I/O bus 2110.

While various embodiments have been described above, it will be understood to those skilled in the art that the embodiments described are by way of example only. Accordingly, the memory device having heterogeneous memories, the computer system including the memory device, and the data management method thereof described herein should not be limited based on the described embodiments.

What is claimed is:

1. A memory system, comprising:
a first memory device having a first memory that includes a plurality of access management regions and a first access latency, each of the access management regions including a plurality of pages, the first memory device configured to detect a hot access management region having an access count that reaches a preset value from the plurality of access management regions, and detect one or more hot pages included in the hot access management region; and
a second memory device having a second access latency that is different from the first access latency of the first memory device,
wherein data stored in the one or more hot pages is migrated to the second memory device.

2. The memory system according to claim 1, wherein:
the first memory device further comprises a first controller configured to control an operation of the first memory, and
wherein the first controller comprises:
a memory comprising an access count table for storing access counts of the plurality of access management regions and a plurality of bit vectors respectively corresponding to the plurality of access management regions, each of the bit vectors including bits that correspond to a plurality of pages included in each of the plurality of access management regions; and
an access manager, when a page in one of the plurality of access management regions is accessed, configured to store an access count of an accessed access management region in a space of the access count table corresponding to the accessed access management region and set a bit corresponding to an accessed page, among bits of a bit vector corresponding to the accessed access management region, to a value indicative of a set state,
wherein the first access latency is longer than the second access latency.

3. The memory system according to claim 2, wherein the first controller is configured to:
check whether the hot access management region is present among the plurality of access management regions based on the access count table when a hot access management region check command is received from an external device, and
transmit a result of the checking to the external device.

4. The memory system according to claim 3, wherein the first controller is configured to:
check a bit vector corresponding to the hot access management region, among the plurality of bit vectors, when the hot access management region is present,
detect the one or more hot pages, corresponding to bits set to the value indicative of the set state among bits of the bit vector corresponding to the hot access management region, from pages in the hot access management region, and
transmit, to the external device, information related to the one or more hot pages.

5. The memory system according to claim 4, wherein the first controller is configured to transmit, to the second memory device, the data stored in the one or more hot pages.

6. The memory system according to claim 3, wherein the first controller is configured to transmit, to the external device, information indicating that the hot access management region is not present when the hot access management region is not present in the first memory.

7. The memory system according to claim 3, wherein the first controller is configured to perform a data migration operation for exchanging hot data stored in the one or more hot pages included in the hot access management region of the first memory with data stored in a second memory of the second memory device when a data migration command is received from the external device.

8. The memory system according to claim 7, wherein:
the first memory comprises a non-volatile memory, and
the second memory comprises a volatile memory.

9. The memory system according to claim 8, wherein:
the non-volatile memory comprises a phase change RAM (PCRAM), and
the volatile memory comprises a dynamic random access memory (DRAM).

10. The memory system according to claim 3, wherein the first controller is configured to reset values stored in the access count table and values in the plurality of bit vectors when a reset command is received from the external device.

11. A computer system, comprising:
a central processing unit (CPU); and
a memory system electrically coupled to the CPU through a system bus,
wherein the memory system comprises:
a first memory device having a first memory that includes a plurality of access management regions and a first access latency, each of the access management regions including a plurality of pages, the first memory device configured to detect a hot access management region having an access count that reaches a preset value from the plurality of access management regions, and detect one or more hot pages included in the hot access management region; and
a second memory device having a second access latency different from the first access latency of the first memory device,
wherein data stored in the one or more hot pages is migrated to the second memory device.

12. The computer system according to claim 11, wherein:
the first memory device further comprises a first controller configured to control an operation of the first memory, and
wherein the first controller comprises:
a memory comprising an access count table for storing access counts of the plurality of access management regions and a plurality of bit vectors respectively corresponding to the plurality of access management regions, each of the bit vectors including bits that correspond to a plurality of pages included in each of the plurality of access management regions; and
an access manager, when a page in one of the plurality of access management regions is accessed, the access manager stores an access count of an accessed access management region in a space of the access count table corresponding to the accessed access management region and set a bit corresponding to an accessed page, among bits of a bit vector corresponding to the accessed access management region, to a value indicative of a set state,
wherein the first access latency is longer than the second access latency.

13. The computer system according to claim 12, wherein the first controller is configured to:
check whether the hot access management region is present among the plurality of access management regions based on the access count table when a hot access management region check command is received from the CPU, and
transmit a result of the checking to the CPU.

14. The computer system according to claim 13, wherein the CPU is configured to transmit, to the first memory device, the hot access management region check command for checking whether the hot access management region is present in the first memory every preset cycle.

15. A data management method for a computer system comprising a central processing unit (CPU) and first and second memory devices, the method comprising:
transmitting, by the CPU, a hot access management region check command to the first memory device for checking whether a hot access management region is present in a first memory of the first memory device;
transmitting, by the first memory device, a first response or a second response to the CPU in response to the hot access management region check command, the first respond including information related to one or more hot pages in the hot access management region, the second response indicating that the hot access management region is not present in the first memory; and
transmitting, by the CPU, a data migration command for exchanging hot data, stored in the one or more hot pages of the first memory, with cold data in a second memory of the second memory device, to the first and second memory devices when the first response is received from the first memory device, the first memory device having longer access latency than the second memory device.

16. The data management method according to claim 15, wherein the transmitting of the hot access management region check command to the first memory device is performed every preset cycle.

17. The data management method according to claim 15, further comprising, after transmitting the data migration command to the memory device:
reading, by the second memory device, the cold data from a cold page of the second memory and temporarily storing the cold data in a buffer memory;
reading, by the first memory device, the hot data from the one or more hot pages of the first memory and transmitting the hot data to the second memory;
storing, by the second memory device, the hot data received from the first memory device in the cold page of the second memory;
transmitting, by the second memory device, the cold data temporarily stored in the buffer memory to the first memory device; and
storing, by the first memory device, the cold data received from the second memory device in the one or more hot pages of the first memory.

18. The data management method according to claim 15, further comprising, after transmitting the hot access management region check command to the first memory device:
checking, by the first memory device, an access count of each of a plurality of access management regions in the first memory;
determining, by the first memory device, whether the hot access management region having an access count that reaches a preset value is present in the plurality of access management regions; and
detecting, by the first memory device, the one or more pages, corresponding to bits set to a value indicative of a set state among bits of a bit vector corresponding to the hot access management region.

19. A memory device, comprising:
a non-volatile memory; and
a controller configured to control an operation of the non-volatile memory,
wherein the controller is configured to divide the non-volatile memory into a plurality of access management regions, each of which comprises a plurality of pages, include an access count table for storing an access count of each of the plurality of access management regions and a plurality of bit vectors configured with bits corresponding to a plurality of pages included in each of the plurality of access management regions, store an access count of an accessed access management region of the plurality of access management regions in a space of the access count table corresponding to the accessed access management region when the non-volatile memory is accessed, and set, as a first value, a bit corresponding to an accessed page among bits of a bit vector corresponding to the accessed access management region.

20. The memory device according to claim 19, further comprising a volatile memory,
wherein the controller is configured to migrate, to the volatile memory, data stored in one or more pages corresponding to one or more bits having the first value in a bit vector, the bit vector corresponding to an access management region having an access count that reaches a preset value among the plurality of access management regions in the non-volatile memory.
